(19) United States
(12) Patent Application Publication
(10) Pub. No.: US 2013/0064192 A1
(43) Pub. Date: Mar. 14, 2013

(54) MOBILE COMMUNICATION METHOD AND MOBILE STATION

(71) Applicants: Mikio Iwamura, Chiyoda-ku (JP); Nobuhiko Miki, Chiyoda-ku (JP); Hiroyuki Ishii, Chiyoda-ku (JP); Anil Umesh, Chiyoda-ku (JP)

(72) Inventors: Mikio Iwamura, Chiyoda-ku (JP); Nobuhiko Miki, Chiyoda-ku (JP); Hiroyuki Ishii, Chiyoda-ku (JP); Anil Umesh, Chiyoda-ku (JP)

(73) Assignee: NTT DOCOMO, INC., Tokyo (JP)

(21) Appl. No.: 13/579,044

(22) PCT Filed: Feb. 15, 2011
(86) PCT No.: PCT/JP2011/053123

§ 371 Date: Nov. 27, 2012

(30) Foreign Application Priority Data
Feb. 15, 2010 (JP) 2010-030746

(51) Int. Cl. H04W 72/04

(52) U.S. Cl. 370/329

(57) ABSTRACT

A mobile communication method according to the present invention includes a step A of transmitting, by a radio base station eNB, “RRC Connection Reconfiguration” including setting information on a plurality of CCs and PDCCHs to a mobile station UE, and a step B of transmitting, by the mobile station UE, “RRC Connection Reconfiguration Complete” to the radio base station eNB using a contention-based channel in response to the received “RRC Connection Reconfiguration”.

### TECHNICAL FIELD

The present invention relates to a mobile communication method and a mobile station.

### BACKGROUND ART

In an LTE (Long Term Evolution)-Advanced mobile communication system, when CA (Carrier Aggregation) is performed, a mobile station UE is configured to communicate with a radio base station eNB using a plurality of “Component Carriers (CCs)” having different carrier frequencies.

Here, when the CA is performed, it is possible for the radio base station eNB to limit CC, which is to be monitored in the mobile station UE among the plurality of CCs, by “PDCCH (Physical Downlink Control Channel) monitoring set”.

Furthermore, when the CA is performed, it is possible for the radio base station eNB to set “CIF configuration”, which indicates a correspondence relationship between each of the plurality of CCs and CIF (Carrier Indication Field) to be set to the PDCCH, in each mobile station UE.

Using the CIF, it is possible for the radio base station eNB to perform “Cross Carrier Scheduling”. That is, using PDCCH to be transmitted on CC configuring the CA, it is possible for the radio base station eNB to designate a resource of PDSCH (Physical Downlink Shared Channel) or PUSCH (Physical Uplink Shared Channel) of another CC configuring the CA.

However, in the above-described mobile communication system, when the radio base station eNB notifies the mobile station UE of a change in the “PDCCH monitoring set” through RRC (Radio Resource Control) signaling, it is not possible for the radio base station eNB to understand a reception timing and a reflection timing of the “PDCCH monitoring set” in the mobile station UE.

Therefore, when “PDCCH monitoring set” managed by the radio base station eNB does not coincide with “PDCCH monitoring set” managed by the mobile station UE, there is a problem that it is not possible for the mobile station UE to receive a downlink control signal transmitted from the radio base station eNB via the PDCCH.

Furthermore, in the above-described mobile communication system, when the radio base station eNB notifies the mobile station UE of a change in the “CIF configuration” through the RRC signaling, it is not possible for the radio base station eNB to understand a reception timing and a reflection timing of the “CIF configuration” in the mobile station UE.

Therefore, when “CIF configuration” managed by the radio base station eNB does not coincide with “CIF configuration” managed by the mobile station UE, there is a problem that it is not possible for the mobile station UE to receive a downlink data signal transmitted from the radio base station eNB via the PDSCH.

Furthermore, there is a problem that it is not possible for the radio base station eNB to receive an uplink data signal transmitted from the mobile station UE via the PUSCH.

### SUMMARY OF THE INVENTION

Therefore, the present invention has been achieved in view of the above-described problems, and an object thereof is to provide a mobile communication method and a mobile station, by which it is possible to achieve coincidence of setting information on PDCCH and CC managed between a radio base station eNB and a mobile station UE when CA is performed.

A first characteristic of the present embodiment is summarized in that a mobile communication method, in which a mobile station communicates with a radio base station using a plurality of carriers having different carrier frequencies, comprising, a step A of transmitting, by the radio base station, a re-setting signal including setting information on the plurality of carriers and physical downlink control channels to the mobile station, and a step B of transmitting, by the mobile station, a response signal for the re-setting signal to the radio base station using a contention-based channel in response to the received re-setting signal.

A second characteristic of the present embodiment is summarized in that a mobile station, which is configured to communicate with a radio base station using a plurality of carriers having different carrier frequencies, comprising, a reception unit configured to receive a re-setting signal including setting information on the plurality of carriers and physical downlink control channels from the radio base station, and a transmission unit configured to transmit a response signal for the re-setting signal received in the reception unit to the radio base station using a contention-based channel.

As described above, according to the present invention, it is possible to provide a mobile communication method and a mobile station, by which it is possible to achieve coincidence of setting information on PDCCH and CC managed between a radio base station eNB and a mobile station UE when CA is performed.

### BRIEF DESCRIPTION OF DRAWINGS

FIG. 1 is a diagram showing the entire configuration of a mobile communication system according to a first embodiment of the present invention.

FIG. 2 is a diagram for explaining CA performed in the mobile communication system according to the first embodiment of the present invention.

FIG. 3 is a functional block diagram of a mobile station according to the first embodiment of the present invention.

FIG. 4 is a functional block diagram of a radio base station according to the first embodiment of the present invention.

FIG. 5 is a sequence diagram for explaining an operation of the mobile communication system according to the first embodiment of the present invention.

FIG. 6 is a sequence diagram for explaining an operation of the mobile communication system according to the first embodiment of the present invention.

### DESCRIPTION OF EMBODIMENTS

### Configuration of Mobile Communication System According to First Embodiment of the Present Invention

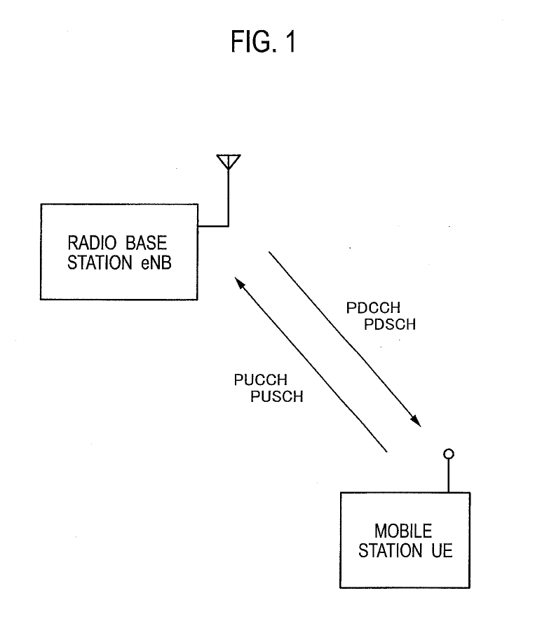

A description will now be provided for the configuration of a mobile communication system according to a first embodiment of the present invention, with reference to FIG. 1 to FIG. 6. The mobile communication system according to the present embodiment is an LTE-advanced mobile communication system.

As illustrated in FIG. 1, in the mobile communication system according to the present embodiment, a mobile station UE is configured to transmit a control signal to a radio base station eNB via PUCCH (Physical Uplink Control Channel), and to transmit a data signal to the radio base station eNB via PUSCH.

Furthermore, in the mobile communication system according to the present embodiment, the radio base station eNB is configured to transmit a control signal to the mobile station UE via PDCCH, and to transmit a data signal to the mobile station UE via PDSCH.

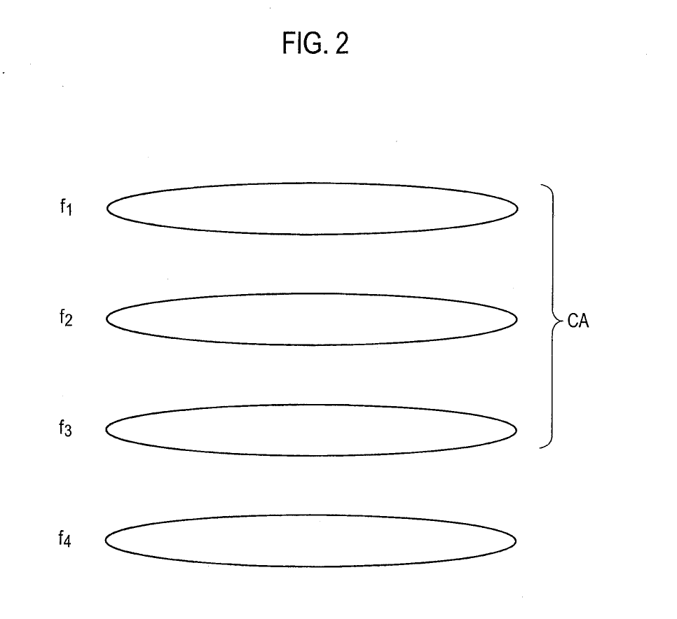

Furthermore, as illustrated in FIG. 2, the mobile communication system according to the present embodiment is configured to use a plurality of CCs having carrier frequencies f1 to f4. Here, in the mobile communication system according to the present embodiment, it is possible for the mobile station UE to perform CA using a predetermined number of CCs (in the example of FIG. 2, for example, three CCs having the carrier frequencies f1 to f3).

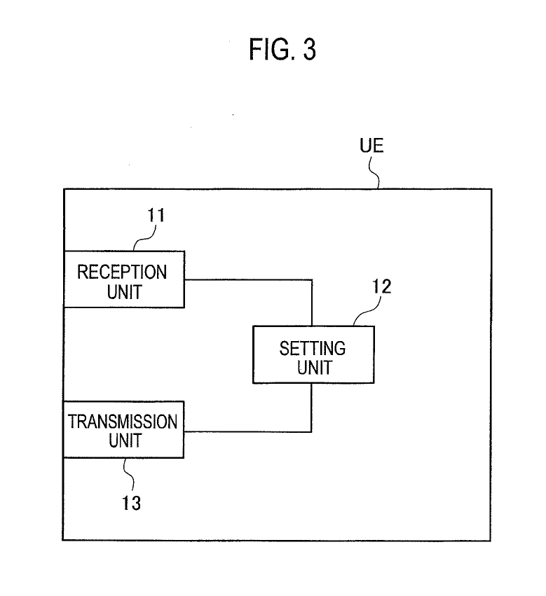

As illustrated in FIG. 3, the mobile station UE includes a reception unit 11, a setting unit 12, and a transmission unit 13.

The reception unit 11 is configured to receive a downlink control signal from the radio base station eNB via the PDCCH, and to receive a downlink data signal from the radio base station eNB via the PDSCH.

Furthermore, the reception unit 11 is configured to receive “RA Response” from the radio base station eNB in an RACH (Random Access Channel) procedure.

Specifically, when the CA is performed, the reception unit 11 is configured to receive “RRC Connection Reconfiguration” including setting information on a plurality of CCs and PDCCHs from the radio base station eNB via the PDSCH.

For example, the setting information on the plurality of CCs and PDCCHs includes “PDCCH monitoring set”, “CIF configuration”, and the like.

Here, the “PDCCH monitoring set” is information indicating the PDCCH to be monitored in the mobile station UE among the plurality of CCs according to the CA. Furthermore, the “CIF configuration” is information (for example, 3-bit information) for associating each of the plurality of CCs with CIF (carrier indication field) to be set to the PDCCH. In addition, the “PDCCH monitoring set” and the “CIF configuration” are settable in each mobile station UE.

The setting unit 12 is configured to perform setting based on the setting information received in the reception unit 11.

For example, the setting unit 12 is configured to set the PDCCH, which is to be monitored in the mobile station UE among the plurality of CCs according to the CA, based on the “PDCCH monitoring set” included in the setting information received in the reception unit 11.

That is, the reception unit 11 is configured to receive the downlink control signal via only the PDCCH set in the setting unit 12.

Furthermore, the setting unit 12 is configured to associate each of the plurality of CCs with the CIF to be set to the PDCCH based on the “CIF configuration” included in the setting information received in the reception unit 11.

The transmission unit 13 is configured to transmit an uplink control signal to the radio base station eNB via the PUCCH, and to transmit an uplink data signal to the radio base station eNB via the PUSCH.

Furthermore, the transmission unit 13 is configured to transmit “RA Preamble” to the radio base station eNB in the RACH procedure.

Here, the transmission unit 13 may be configured to transmit “Dedicated Preamble” designated by the “RRC Connection Reconfiguration”.

Furthermore, when the “Dedicated Preamble” has not been designated by the “RRC Connection Reconfiguration”, the transmission unit 13 may be configured to transmit a “Contention Preamble”.

Moreover, the transmission unit 13 is configured to transmit a response signal for the “RRC Connection Reconfiguration” received in the reception unit 11 to the radio base station eNB using a contention-based channel.

Here, the transmission unit 13 may be configured to transmit, as the response signal, the “Dedicated Preamble” and “RRC Connection Reconfiguration Complete” designated for the mobile station UE.

In such a case, the transmission unit 13 is configured to transmit the “Dedicated Preamble” using RACH as the contention-based channel, and to transmit the “RRC Connection Reconfiguration Complete” using uplink radio resources (UL PRBs: Physical Resource Blocks) designated by the “RA Response”.

Furthermore, the transmission unit 13 may be configured to transmit, as the response signal, identification information of the mobile station UE, for example, “RRC Connection Reconfiguration Complete” having a “C-RNTI MAC control element” added thereto.

In such a case, the transmission unit 13 is configured to transmit the “RRC Connection Reconfiguration Complete” having the “C-RNTI MAC control element” added thereto using the uplink radio resources (UL PRBs), which have been designated by PDCCH transmitted to RNTI dedicated for a “contention based UL grant”, that is, CB-RNTI (Contention Based-Radio Network Temporary Identity), as the contention-based channel.

Moreover, the transmission unit 13 may be configured to transmit, as the response signal, the “RRC Connection Reconfiguration Complete” having the “Contention preamble” and the “C-RNTI MAC control element” added thereto.

In such a case, the transmission unit 13 is configured to transmit the “Contention preamble” using the RACH as the contention-based channel, and to transmit the “RRC Connection Reconfiguration Complete” having the “C-RNTI MAC control element” added thereto using the uplink radio resources (UL PRBs) designated by the PDCCH transmitted to the CB-RNTI.

Furthermore, the transmission unit 13 may be configured to transmit a response signal for the “RRC Connection Reconfiguration” using a previously acquired one of the uplink radio resources (UL PRBs), which have been designated by the RACH or the PDCCH transmitted to the CB-RNTI, as the contention-based channel.

In addition, the transmission unit 13 is configured to transmit an uplink data signal via the PUSCH based on a “UL grant” received via the PDCCH received in the reception unit 11. In such a case, the transmission unit 13 is configured to transmit the uplink data signal using CC corresponding to the CIF set to the PDCCH.

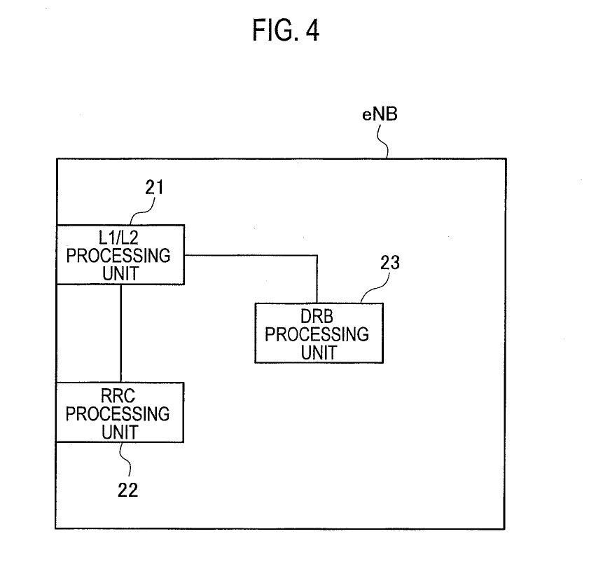

As illustrated in FIG. 4, the radio base station eNB includes an L1/L2 processing unit 21, an RRC processing unit 22, and a DRB (Data Radio Bearer) processing unit 23.

The L1/L2 processing unit 21 is configured to perform a physical layer process, a scheduling process, and the like.

The RRC processing unit 22 is configured to perform a control process according to a C-plane, and the DRB processing unit 23 is configured to perform a transmission and reception process of U-plane data.

(Operation of the Mobile Communication System According to the First Embodiment of the Present Invention)

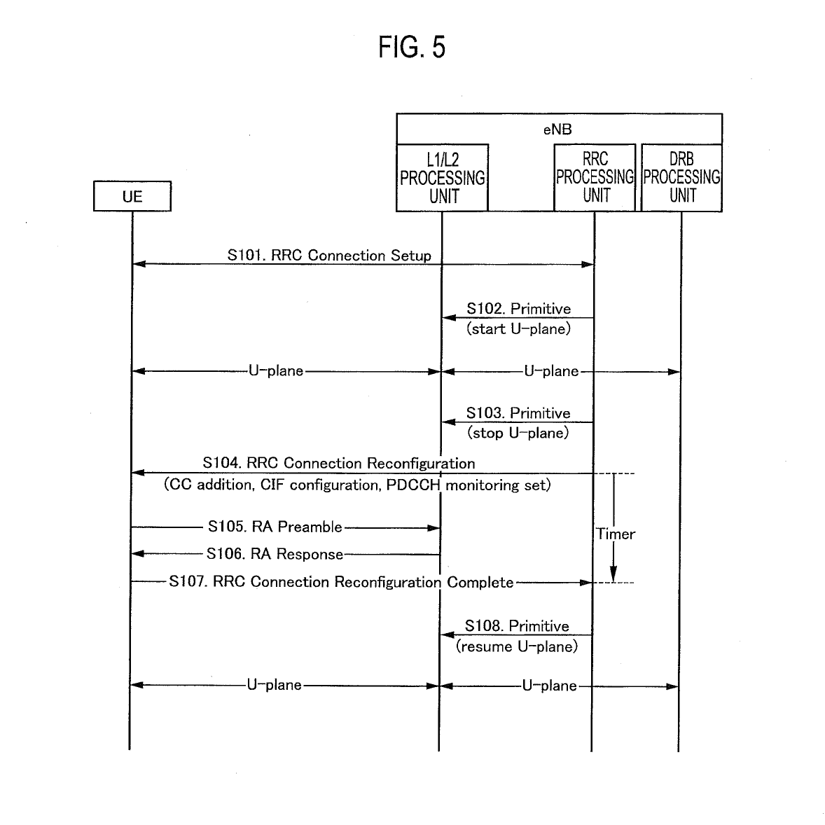

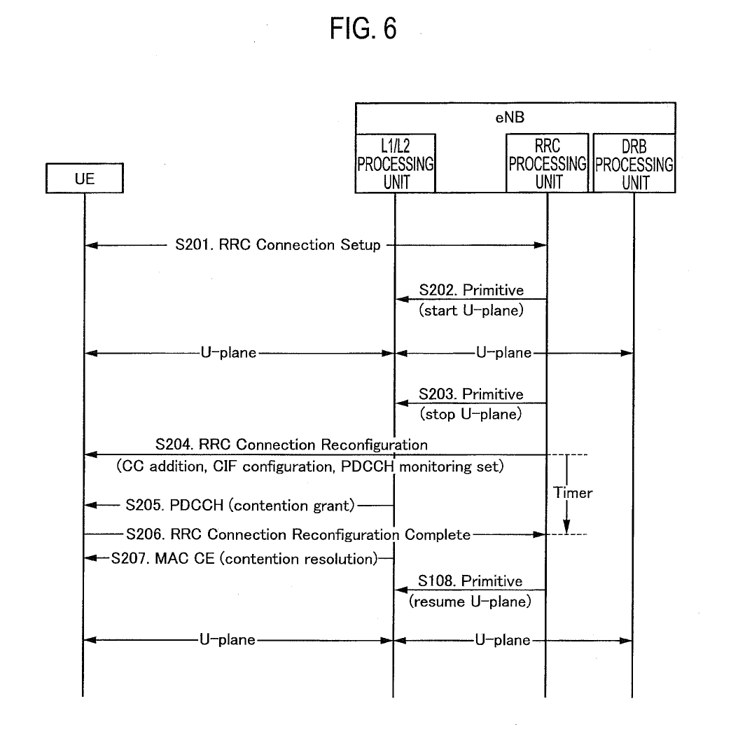

With reference to FIG. 5 and FIG. 6, the operation of the mobile communication system according to the first embodiment of the present invention will be explained.

Firstly, with reference to FIG. 5, a first example of the operation of the mobile communication system according to the first embodiment of the present invention will be described.

As illustrated in FIG. 5, in step S101, the RRC processing unit 22 of the radio base station eNB performs an “RRC Connection Setup process” with the mobile station UE.

In step S102, the RRC processing unit 22 of the radio base station eNB transmits “Primitive” for starting a U-plane to the L1/L2 processing unit 21 of the radio base station eNB.

As a consequence, data transmission and reception of the U-plane is started between the DRB processing unit 23 of the radio base station eNB and the L1/L2 processing unit 21 of the radio base station eNB, and between the L1/L2 processing unit 21 of the radio base station eNB and the mobile station UE.

Then, in step S103, the RRC processing unit 22 of the radio base station eNB transmits “Primitive” for temporarily stopping the U-plane to the L1/L2 processing unit 21 of the radio base station eNB.

In step S104, the RRC processing unit 22 of the radio base station eNB transmits “RRC Connection Reconfiguration”, which includes information indicating CC to be added in CA, a changed content of “CIF Configuration”, a changed content of “PDCCH monitoring set”, and the like, to the mobile station UE, thereby activating a predetermined timer.

The mobile station UE transmits “RA Preamble” to the L1/L2 processing unit 21 of the radio base station eNB using RACH as a response signal for the “RRC Connection Reconfiguration” in step S105, and acquires “RA Response” from the L1/L2 processing unit 21 of the radio base station eNB in step S106.

In step S107, the mobile station UE transmits “RRC Connection Reconfiguration Complete” to the RRC processing unit 22 of the radio base station eNB via an uplink radio resource (UL PRB) designated by the “RA Response”.

When “Contention Preamble” has been transmitted as the “RA Preamble” in step S105, the mobile station UE transmits the “RRC Connection Reconfiguration Complete” via the uplink radio resource (UL PRB) designated by the “RA Response”, and simultaneously transmits a “C-RNTI MAC control element” to the L1/L2 processing unit 21 of the radio base station eNB.

Then, the L1/L2 processing unit 21 of the radio base station eNB transmits “MAC CE (contention resolution)” for the “RRC Connection Reconfiguration Complete” to the mobile station UE.

It is possible for the radio base station eNB to uniquely identify the mobile station UE by receiving the “C-RNTI MAC control element” from the mobile station UE, and to understand that the “RRC Connection Reconfiguration” has been received and correctly processed by the mobile station UE by receiving the “RRC Connection Reconfiguration Complete”.

Consequently, it is possible to perform subsequent communication using the “PDCCH monitoring set” or the “CIF configuration” set by the “RRC Connection Reconfiguration”.

Furthermore, when “Dedicated Preamble” has been transmitted as the “RA Preamble” in step S105, it is possible for the L1/L2 processing unit 21 of the radio base station eNB to uniquely identify the mobile station UE from the received “Dedicated Preamble”.

Furthermore, it is possible for the radio base station eNB to understand that the “RRC Connection Reconfiguration” has been received and correctly processed by the mobile station UE by receiving the “RRC Connection Reconfiguration Complete” via the uplink radio resource (UL PRB) designated by the “RA Response”.

Consequently, it is possible to perform subsequent communication using the “PDCCH monitoring set” or the “CIF configuration” set by the “RRC Connection Reconfiguration”.

If the “RRC Connection Reconfiguration Complete” is received before the predetermined timer expires, the RRC processing unit 22 of the radio base station eNB transmits “Primitive” for resuming the U-plane to the L1/L2 processing unit 21 of the radio base station eNB in step S108.

As a consequence, the U-plane is resumed between the DRB processing unit 23 of the radio base station eNB and the L1/L2 processing unit 21 of the radio base station eNB, and between the L1/L2 processing unit 21 of the radio base station eNB and the mobile station UE.

In addition, if the “RRC Connection Reconfiguration Complete” is not received before the predetermined timer expires, the RRC processing unit 22 of the radio base station eNB performs operations such as performing a resumption process of the U-plane and transitioning to a reconnection waiting state while the U-plane is being stopped.

Secondly, with reference to FIG. 6, a second example of the operation of the mobile communication system according to the first embodiment of the present invention will be described.

As illustrated in FIG. 6, operations from steps S201 to S204 are equal to the operations from steps S101 to S104 illustrated in FIG. 5.

In step S205, the L1/L2 processing unit 21 of the radio base station eNB transmits a “Contention based UL grant” for designating an uplink radio resource to the mobile station UE via PDCCH to which CB-RNTI has been set.

In step S206, the mobile station UE transmits “RRC Connection Reconfiguration Complete” to the RRC processing unit 22 of the radio base station eNB via an uplink radio resource (UL PRB), which has been designated by the “Contention based UL grant”, as a response signal for “RRC Connection Reconfiguration”.

At this time, the mobile station UE adds a “C-RNTI MAC control element” to the “RRC Connection Reconfiguration Complete”, and then transmits the “RRC Connection Reconfiguration Complete”.

It is possible for the radio base station eNB to uniquely identify the mobile station UE by receiving the “C-RNTI MAC control element” from the mobile station UE, and to understand that the “RRC Connection Reconfiguration” has been received and correctly processed by the mobile station UE by receiving the “RRC Connection Reconfiguration Complete”.

Consequently, it is possible to perform subsequent communication using the “PDCCH monitoring set” or the “CIF configuration” set by the “RRC Connection Reconfiguration”.

In step S207, the L1/L2 processing unit 21 of the radio base station eNB transmits “MAC CE (contention resolution)” for the “RRC Connection Reconfiguration Complete” to the mobile station UE.

If the “RRC Connection Reconfiguration Complete” is received before the predetermined timer expires, the RRC processing unit 22 of the radio base station eNB transmits “Primitive” for resuming the U-plane to the L1/L2 processing unit 21 of the radio base station eNB in step S208.

As a consequence, the U-plane is resumed between the DRB processing unit 23 of the radio base station eNB and the L1/L2 processing unit 21 of the radio base station eNB, and between the L1/L2 processing unit 21 of the radio base station eNB and the mobile station UE.

In addition, if the “RRC Connection Reconfiguration Complete” is not received before the predetermined timer expires, the RRC processing unit 22 of the radio base station eNB performs operations such as performing a resumption process of the U-plane and transitioning to a reconnection waiting state while the U-plane is being stopped.

(Operation and Effect of the Mobile Communication System According to the First Embodiment of the Present Invention)

In accordance with the mobile communication system according to the present embodiment, when the “RRC Connection Reconfiguration” is received, the mobile station UE is configured to transmit the response signal including the identification information of the mobile station UE for the “RRC Connection Reconfiguration” using the contention-based channel to the radio base station eNB, so that it is possible for the radio base station eNB to understand the reception and reflection timings of the “RRC Connection Reconfiguration” in the mobile station UE.

The characteristics of the present embodiment as described above may be expressed as follows.

A first characteristic of the present embodiment is summarized in that in a mobile communication method, in which a mobile station UE communicates with a radio base station eNB using a plurality of CCs (carriers) having different carrier frequencies, (CA), includes: a step A of transmitting, by the radio base station eNB, “RRC Connection Reconfiguration (a re-setting signal)” including setting information on the plurality of CCs and PDCCHs (Physical Downlink Control Channels) to the mobile station UE; and a step B of transmitting, by the mobile station UE, a response signal for the “RRC Connection Reconfiguration” to the radio base station eNB using a contention-based channel in response to the received “RRC Connection Reconfiguration”.

In the first characteristic of the present embodiment, in the step B, the mobile station UE may transmit the above-described response signal using RACH as the contention-based channel.

In the first characteristic of the present embodiment, in the step B, the mobile station UE may transmit “Dedicated RA Preamble (individual RA preamble)”, which has been designated to the mobile station UE by the radio base station eNB, as the above-described response signal.

In such a case, for example, the above-described response signal may be “RRC Connection Reconfiguration Complete” to which the “Dedicated RA Preamble” and a “C-RNTI MAC control element” have not been added.

In the first characteristic of the present embodiment, in the step B, the mobile station UE may transmit the above-described response signal using uplink radio resources, which have been designated by PDCCH (Physical Downlink Control Channel) transmitted to RNTI dedicated for a “contention based UL grant”, that is, CB-RNTI (predetermined RNTI), as the contention-based channel.

In the first characteristic of the present embodiment, in the step B, the mobile station UE may allow identification information of the mobile station UE to be included in the above-described response signal. In the first characteristic of the present embodiment, the above-described identification information of the mobile station UE may be a “C-RNTI MAC control element”.

In such a case, for example, the above-described response signal may be “RRC Connection Reconfiguration Complete” to which the “C-RNTI MAC control element” has been added.

In addition, the above-described response signal may be “RRC Connection Reconfiguration Complete” to which the “Contention RA Preamble” and the “C-RNTI MAC control element” have been added.

In the first characteristic of the present embodiment, in the step B, the mobile station UE may transmit the above-described response signal using one previously having a transmission opportunity of the uplink radio resources, which have been designated by the RACH or the PDCCH transmitted to the CB-RNTI, as the contention-based channel.

A second characteristic of the present embodiment is summarized in that in a mobile station UE, which is configured to communicate with a radio base station eNB using a plurality of CCs having different carrier frequencies, includes: a reception unit 11 configured to receive “RRC Connection Reconfiguration” including setting information on the plurality of CCs and PDCCHs from the radio base station eNB; and a transmission unit 13 configured to transmit a response signal for the “RRC Connection Reconfiguration” to the radio base station eNB using a contention-based channel.

In the second characteristic of the present embodiment, the transmission unit 13 may be configured to transmit the above-described response signal using RACH as the contention-based channel.

In the second characteristic of the present embodiment, the transmission unit 13 may be configured to transmit “Dedicated RA Preamble”, which has been designated to the mobile station UE by the radio base station eNB, as the above-described response signal.

In the second characteristic of the present embodiment, the transmission unit 13 may be configured to transmit the above-described response signal using uplink radio resources designated by PDCCH transmitted to CB-RNTI as the contention-based channel.

In the second characteristic of the present embodiment, the transmission unit 13 may be configured to allow identification information of the mobile station UE to be included in the above-described response signal. In the second characteristic of the present embodiment, the identification information of the mobile station UE may be a “C-RNTI MAC control element”.

In the second characteristic of the present embodiment, the transmission unit 13 may be configured to transmit the above-described response signal using one previously having a transmission opportunity of the uplink radio resources, which have been designated by the RACH or the PDCCH transmitted to the CB-RNTI, as the contention-based channel.

In the first and second characteristics of the present embodiment, the setting information may include information indicating the PDCCH to be monitored (PDCCH monitoring set) in the mobile station UE among the plurality of CCs.

In the first and second characteristics of the present embodiment, the setting information may include information (CIF configuration) for associating each of the plurality of CCs with carrier indication field (CIF) to be set to the PDCCH.

It is noted that the operation of the above-described the mobile station UE or the radio base station eNB may be implemented by a hardware, may also be implemented by a software module executed by a processor, and may further be implemented by the combination of the both.

The software module may be arranged in a storage medium of an arbitrary format such as RAM (Random Access Memory), a flash memory, ROM (Read Only Memory), EPROM (Erasable Programmable ROM), EEPROM (Electronically Erasable and Programmable ROM), a register, a hard disk, a removable disk, and CD-ROM.

The storage medium is connected to the processor so that the processor can write and read information into and from the storage medium. Such a storage medium may also be accumulated in the processor. The storage medium and processor may be arranged in ASIC. Such the ASIC may be arranged in the mobile station UE or the radio base station eNB. Further, such a storage medium or a processor may be arranged, as a discrete component, in the mobile station UE or the radio base station eNB.

Thus, the present invention has been explained in detail by using the above-described embodiments; however, it is obvious that for persons skilled in the art, the present invention is not limited to the embodiments explained herein. The present invention can be implemented as a corrected and modified mode without departing from the gist and the scope of the present invention defined by the claims. Therefore, the description of the specification is intended for explaining the example only and does not impose any limited meaning to the present invention.

### INDUSTRIAL APPLICABILITY

As described above, in accordance with the present invention, it is possible to provide a mobile communication method and a mobile station, by which it is possible to achieve coincidence of setting information on PDCCH and CC managed between a radio base station eNB and a mobile station UE when CA is performed.

### REFERENCE SIGNS LIST

UE . . . Mobile station
11 . . . Reception unit
12 . . . Setting unit
13 . . . Transmission unit
eNB . . . Radio base station
21 . . . L1/L2 processing unit
22 . . . RRC processing unit
23 . . . DRB processing unit

1. A mobile communication method, in which a mobile station communicates with a radio base station using a plurality of carriers having different carrier frequencies, comprising:
a step A of transmitting, by the radio base station, a re-setting signal including setting information on the plurality of carriers and physical downlink control channels to the mobile station; and
a step B of transmitting, by the mobile station, a response signal for the re-setting signal to the radio base station using a contention-based channel in response to the received re-setting signal.

2. The mobile communication method according to claim 1, wherein, in the step B, the mobile station transmits the response signal using RACH as the contention-based channel.

3. The mobile communication method according to claim 2, wherein, in the step B, the mobile station transmits an individual RA preamble, which has been designated to the mobile station by the radio base station, as the response signal.

4. The mobile communication method according to claim 1, wherein, in the step B, the mobile station transmits the response signal using uplink radio resources, which have been designated by a physical downlink control channel transmitted to predetermined RNTI, as the contention-based channel.

5. The mobile communication method according to claim 4, wherein, in the step B, the mobile station allows identification information of the mobile station to be included in the response signal.

6. The mobile communication method according to claim 5, wherein the identification information of the mobile station includes a “C-RNTI MAC control element”.

7. The mobile communication method according to claim 1, wherein, in the step B, the mobile station transmits the response signal using one previously having a transmission opportunity of the uplink radio resources, which have been designated by the RACH or the physical downlink control channel transmitted to the predetermined RNTI, as the contention-based channel.

8. The mobile communication method according to claim 1, wherein the setting information includes information indicating the physical downlink control channel to be monitored in the mobile station among the plurality of carriers.

9. The mobile communication method according to claim 1, wherein the setting information includes information for associating each of the plurality of carriers with carrier indication field to be set to the physical downlink control channel.

10. A mobile station, which is configured to communicate with a radio base station using a plurality of carriers having different carrier frequencies, comprising:
a reception unit configured to receive a re-setting signal including setting information on the plurality of carriers and physical downlink control channels from the radio base station; and
a transmission unit configured to transmit a response signal for the re-setting signal received in the reception unit to the radio base station using a contention-based channel.

11. The mobile station according to claim 10, wherein the transmission unit is configured to transmit the response signal using RACH as the contention-based channel.

12. The mobile station according to claim 11, wherein the transmission unit is configured to transmit an individual RA preamble, which has been designated to the mobile station by the radio base station, as the response signal.

13. The mobile station according to claim 10, wherein the transmission unit is configured to transmit the response signal using uplink radio resources, which have been designated by a physical downlink control channel transmitted to predetermined RNTI, as the contention-based channel.

14. The mobile station according to claim 13, wherein the transmission unit is configured to allow identification information of the mobile station to be included in the response signal.

15. The mobile station according to claim 14, wherein the identification information of the mobile station includes a “C-RNTI MAC control element”.

16. The mobile station according to claim 10, wherein the transmission unit is configured to transmit the response signal using one previously having a transmission opportunity of the uplink radio resources, which have been designated by the RACH or the physical downlink control channel transmitted to the predetermined RNTI, as the contention-based channel.

17. The mobile station according to claim 10, wherein the setting information includes information indicating the physical downlink control channel to be monitored in the mobile station among the plurality of carriers.

18. The mobile station according to claim 10, wherein the setting information includes information for associating each of the plurality of carriers with carrier indication field to be set to the physical downlink control channel.
